(19) United States
(12) Patent Application Publication
(10) Pub. No.: US 2025/0116178 A1
(43) Pub. Date: Apr. 10, 2025

(54) METHODS AND SYSTEMS FOR AUTOMATICALLY POSITIONING WELLS BASED UPON A RESERVOIR MODEL

(71) Applicant: SAUDI ARABIAN OIL COMPANY, Dhahran (SA)

(72) Inventor: Menhal A. Al-Ismael, Qatif (SA)

(73) Assignee: SAUDI ARABIAN OIL COMPANY, Dhahran (SA)

(21) Appl. No.: 18/481,094

(22) Filed: Oct. 4, 2023

(51) Int. Cl. E21B 43/20; E21B 44/00; G01V 99/00

(52) U.S. Cl. CPC E21B 43/20; E21B 43/30; G01V 20/00

(57) ABSTRACT

Methods and systems are discussed. In some cases, the methods may include receiving a hydrocarbon-water contact. The hydrocarbon-water contact includes a base-polygon formed by projecting a location of contact points between a hydrocarbon zone and a water zone on an upper surface of a reservoir onto a horizontal plane. A wellbore planning system is used to determine a boundary zone that extends away from a boundary of the base-polygon, and to plan a wellbore trajectory penetrating the boundary zone.

### BACKGROUND

Extracting hydrocarbon from a subterranean reservoir includes drilling a number of producer wells that extend into the subterranean reservoir and may include drilling a number of injector wells extending into an aquifer surrounding the subterranean reservoir. As hydrocarbon is extracted from the subterranean reservoir using the producer wells, water is injected into the aquifer to support and help maintain reservoir pressure and reservoir sweep.

There is a need in the art for methods and systems for generating the location of future producer wells and injector wells that will support hydrocarbon extraction from a subterranean reservoir.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to methods including receiving a hydrocarbon-water contact, where the hydrocarbon-water contact includes a base-polygon formed by projecting a location of contact points between a hydrocarbon zone and a water zone on an upper surface of a reservoir onto a horizontal plane. Using a wellbore planning system, such methods further include determining a boundary zone that extends away from a boundary of the base-polygon, and planning a wellbore trajectory penetrating the boundary zone.

In general, in one aspect, embodiments relate to a system including a wellbore planning system, a wellbore drilling system, and a pumping system. The wellbore planning system may be configured to receive a hydrocarbon-water contact, where the hydrocarbon-water contact includes a base-polygon formed by projecting a location of contact points between a hydrocarbon zone and a water zone on an upper surface of a reservoir onto a horizontal plane. The wellbore planning system may be further configured to determine a boundary zone, where the boundary zone extends outwards from a boundary of the base-polygon into the water zone, and plan a wellbore trajectory penetrating the boundary zone. The wellbore drilling system may be configured to drill a wellbore guided by the planned wellbore trajectory and the pumping system, configured to inject a volume of water into the drilled wellbore.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1B illustrate a hydrocarbon reservoir and reservoir simulation model in accordance with one or more embodiments.

FIG. 2 is a flow diagram showing a method in accordance with some embodiments for automatically generating locations for a number of injector wells and well trajectories.

FIGS. 3A-3I are top view, two-dimensional diagrams showing example processes in the well location and well trajectory process of FIG. 2.

FIG. 4 is a flow diagram showing a method in accordance with some embodiments for automatically generating locations for a number of producer wells and well trajectories.

FIGS. 5A-5I are top view, two-dimensional diagrams showing example processes in the well location and well trajectory process of FIG. 4.

FIG. 6 is a top view, two-dimensional diagram of a number of producer wells and number of injector wells placed in relation to a hydrocarbon zone.

FIG. 7 is a flow diagram showing a method in accordance with some embodiments.

FIG. 8 shows a computer system in accordance with one or more embodiments.

### DETAILED DESCRIPTION

Various embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

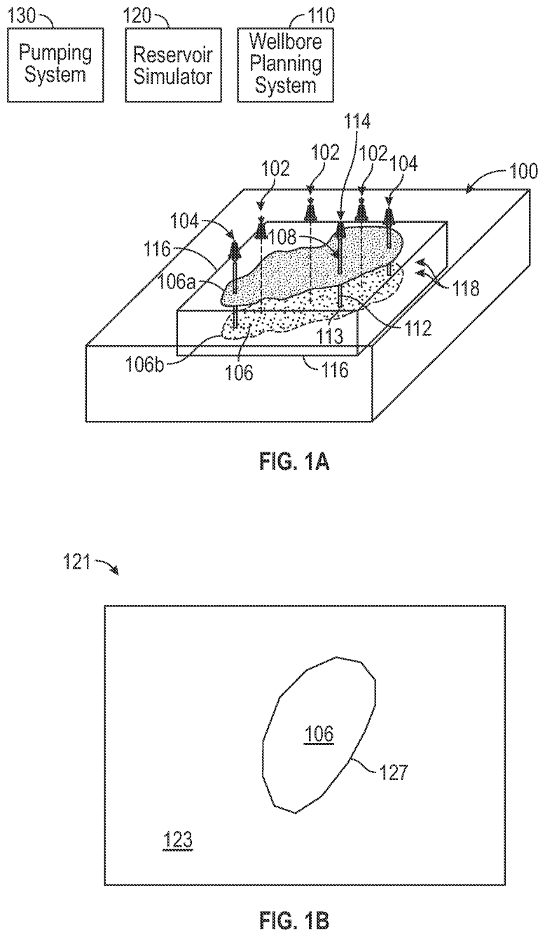

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Reservoir simulation plays an important role in planning and managing a hydrocarbon reservoir. Among other things, reservoir simulation involves developing a map of a hydrocarbon zone. The edge of the hydrocarbon zone is basically a circumference of a hydrocarbon zone, which can be defined using hydrocarbon-water contact or oil-gas contact. At the oil water contact, a polygon is created which encloses the hydrocarbon zone. The region outside the polygon defines a surrounding area (i.e., an aquifer or a gas cap) in which injection is performed.

While the details of developing the polygon defining the edge of the hydrocarbon zone is beyond the scope of this disclosure, the polygon is used in a various embodiments disclosed herein for automatically locating a number of producer wells and injector wells in relation to the hydrocarbon zone. In some embodiments, placement locations and design trajectories of producer wells and injector wells are automatically generated and incorporated in a hydrocarbon reservoir model. As just one of many advantages, hydrocarbon field plans including peripheral injection design patterns to maintain reservoir pressure (energy), increase sweep efficiency, and maximize recovery can be practically and economically developed. Some embodiments can be used to support full field development planning processes involving a large number of wells and uncertainty sensitivities. Such full field development is complicated as the azimuth of each of the injector wells may need to be determined differently.

Turning to FIG. 1A, a hydrocarbon reservoir 106 in a subterranean region 100 is shown that includes both injector wells 104 and producer wells 102 in accordance with one or more embodiments. Producer wells 102 are used to extract hydrocarbon from hydrocarbon reservoir 106, and injector wells 104 are used to enhance production of one or more neighboring producer wells 102. For example, a pumping system 130 may inject a fluid via injector wells 104 to maintain reservoir pressure and to sweep hydrocarbon, such as oil and gas, through the hydrocarbon reservoir towards producer wells 102. Both producer wells 102 and injector wells may extend from the surface of the Earth through various overburden layers to penetrate the hydrocarbon reservoir that may be bounded by an upper reservoir surface 106a and a lower reservoir surface 106b.

A reservoir simulation model 116 may be created or obtained for hydrocarbon reservoir 106. Reservoir simulation model 116 digitally represents all or a portion of hydrocarbon reservoir 106 in a reservoir simulator 120. Reservoir simulation model 116 may be composed of a plurality of cells (not shown). Reservoir simulator 120 may be used to simulate, or model, the percolation of reservoir fluid through hydrocarbon reservoir 106.

Reservoir simulation model 116 may include a number of other elements that are beyond the scope of this disclosure including, but not limited to, the spatial variation of reservoir properties. For example, the reservoir properties may include the geometry of the reservoir, including the location of the geological boundaries that define the upper and lower surfaces of the reservoir and the location of any geological faults, fracture and fracture swarms within the reservoir. The reservoir properties may also include physical properties such as, without limitation, electrical resistivity, self-potential, acoustic wave propagation velocity, density, gamma-ray emission and the pressure of the reservoir fluid and the temperature of the reservoir. The reservoir properties may also include information derived, inverted, or interpreted from these physical properties, such as rock or “facies” types, e.g., carbonate, sandstone, shale, salt. Further, reservoir properties may include characteristic of particular importance to the study of reservoir fluid percolation through the reservoir. Specifically, reservoir properties may include porosity, quantifying the amount of volume between the grains of a rock per unit volume of bulk rock, that may be occupied by reservoir fluid; permeability quantifying the ease with which reservoir fluids may percolate through the rock; the initial pressures of the reservoir fluid and the temperature of the reservoir. Further, the reservoir properties may include the composition of the reservoir fluids, and their phases, i.e., liquid or gas.

A wellbore planning system 110 in accordance with some embodiments may be used to automatically generate location and trajectories of one or both of producer wells 102 and injector wells 104. The output from wellbore planning system 110 may be incorporated into reservoir simulation model 116 and used by reservoir simulator 120. Wellbore planning system 110 may automatically locate and provides well trajectories for a number of producer wells 102 and a number of injector wells 104. An example of such a well trajectory is shown as a planned wellbore path 112 at a location 113. Such wellbores may be drilled along a trajectory guided by the planned wellbore path 112 using a drilling system 114. In some embodiments, wellbore planning system 110 performs one or more of the following processes: (a) automatically locating injector wells 104 and well trajectories using polygons generated based upon a polygon representing the hydrocarbon-water contact of hydrocarbon reservoir 106; and/or (b) automatically locating producer wells 102 and generating well trajectories using backward propagation of the polygon representing the hydrocarbon-water contact hydrocarbon reservoir 106. The processes may include linear interpolation of contour lines and polygons to yield a defined distance between points such that well trajectories each include a number of points along a polygon or contour line. In some cases, the processes are fully automated relying on only minimal control parameters.

Although FIG. 1A shows, for clarity, only a handful of vertical wells, this simplification is not intended to limit the scope of the invention in anyway. Realistic hydrocarbon reservoirs may contain hundreds, or thousands, of wells each of which may be vertical, highly-deviated, or horizontal and which may contain multiple branches (“multilaterals”) from a single parent wellbore.

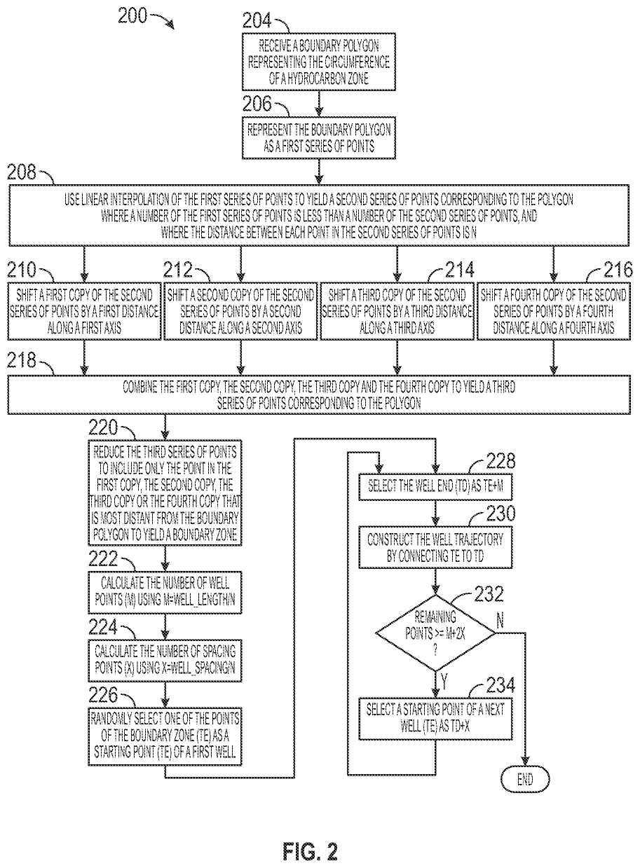

Either or both of reservoir simulator 120 and wellbore planning system 110 may be implemented in a computer system, such as computer system 800 discussed below in relation to in FIG. 8, and equipped with dedicated software configured to form, manipulate and display reservoir simulation model 116, and/or generate a well plan using wellbore planning system 110. Wellbore planning system 110 may be implemented to include various of the well locating processes discussed below in relation to FIGS. 2-5.

Turning to FIG. 1B, a top view, two-dimensional diagram 121 of hydrocarbon reservoir 106 is shown with a boundary polygon 127. Boundary polygon 127 defines an edge between hydrocarbon reservoir 106 and a surrounding region 123 (e.g., an aquifer or gas cap), which can be defined using, for example, hydrocarbon-water contact. In some cases, the hydrocarbon-water contact is where the surface between a hydrocarbon reservoir and an aquifer intersects another surface, such as, for example, the top of the hydrocarbon reservoir. In some such cases, the aquifer lies beneath the entire oil layer with the oil floating on the water of the underlying aquifer. The details of developing boundary polygon 127 are beyond the scope of this disclosure, but as discussed below this boundary polygon is used to identify the locations of one or both of producer wells 102 and injector wells 104. While boundary polygon 127 is shown as having thirteen (13) sides, one of ordinary skill in the art will recognize that more or fewer sides may be used to represent the boundary of a hydrocarbon reservoir.

Turning to FIG. 2, a flow diagram 200 shows a method in accordance with one or more embodiments for automatically generating locations for a number of injector wells and well trajectories. In some embodiments, the method is performed by a wellbore planning system. Following follow diagram 200, a boundary polygon representing the circumference of a hydrocarbon zone is received (block 204). Such a boundary polygon may be generated using any technology in the art for identifying a contact boundary between a hydrocarbon zone and a surrounding region. Such a boundary polygon may be developed using one or both of a hydrocarbon-water contact.

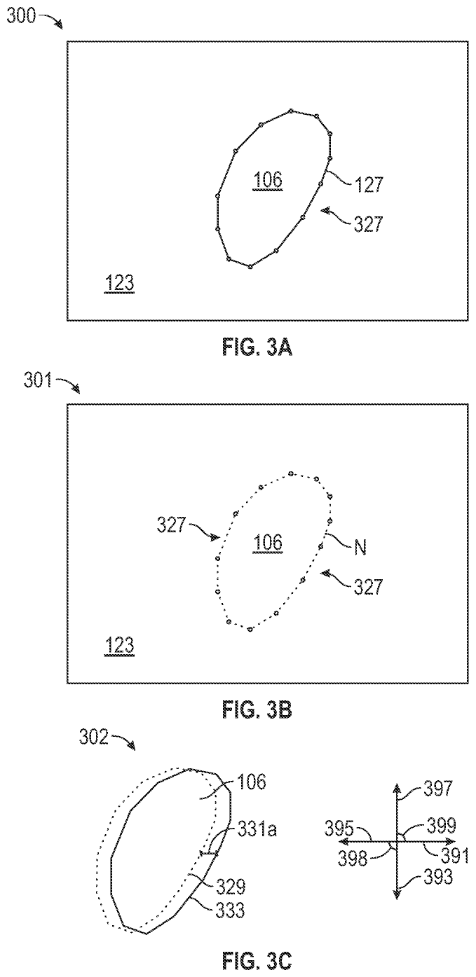

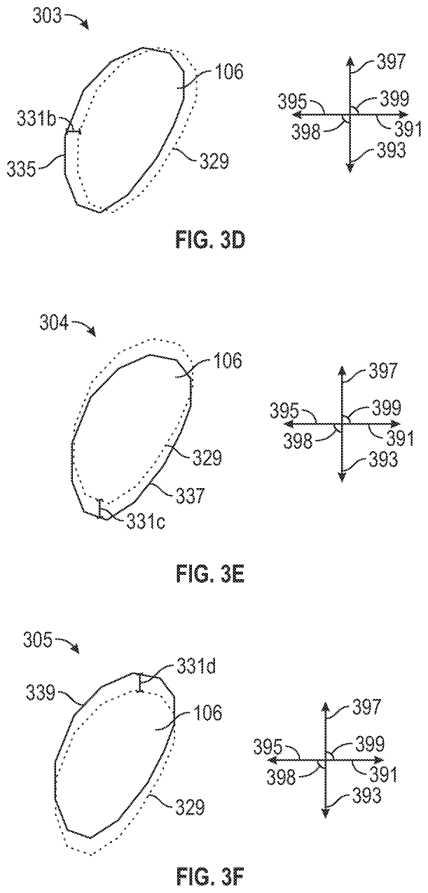

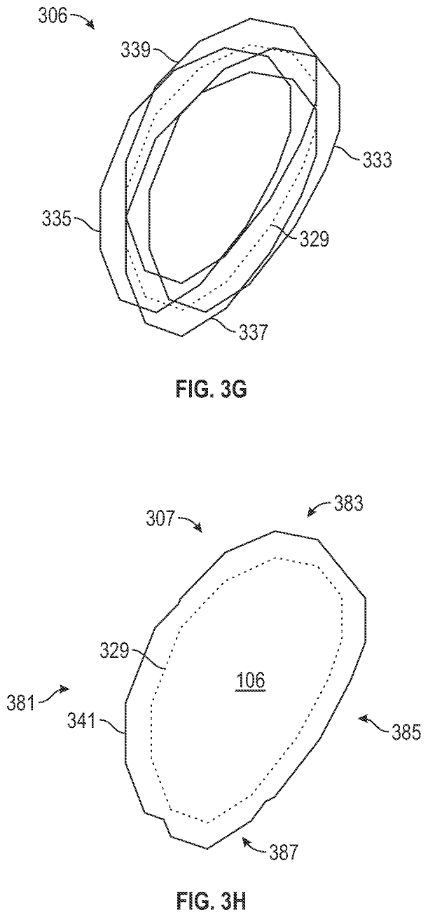

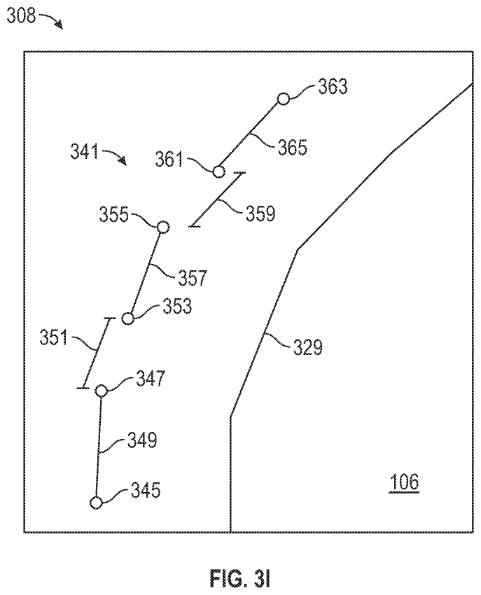

The boundary polygon is represented as a first series of points located at the junction of each of the sides of the boundary polygon (block 206). Turning to FIG. 3A, a top view, two-dimensional diagram 300 shows an example of representing boundary polygon 127 as a first series of points 327 located at the junction of each of the polygon sides.

Returning to FIG. 2, linear interpolation is applied to the first series of points to yield a second series of points extending between respective ones of the first series of points along the perimeter of the boundary polygon (block 208). The linear interpolation results in a distance N between each of the points of the second series of points. In some embodiments, the distance N may be user programmable. In other embodiments, the distance N is a fixed parameter in a wellbore planning system in which the method is implemented. Based upon the disclosure provided herein, one of ordinary skill in the art will recognize a variety of values for N that may be used in relation to different embodiments and/or implementations thereof. Turning to FIG. 3B, a top view, two-dimensional diagram 301 shows an example of an interpolated second series of points 329 (i.e., the smaller points) extending between respective ones of the first series of points 327 (i.e., the larger points) along the perimeter of the boundary polygon. The distance between each of the second series of points is equal to the distance N.

Returning to FIG. 2, a first copy of the second series of points is shifted by a first distance along a first axis to yield a first shifted-polygon (block 210), a second copy of the second series of points is shifted by a second distance along a second axis to yield a second shifted-polygon (block 212); a third copy of the second series of points is shifted by a third distance along a third axis to yield a third shifted-polygon (block 214); and a fourth copy of the second series of points is shifted by a fourth distance along a fourth axis to yield a fourth shifted-polygon (block 216). While this embodiment is described as shifting four copies of the second series of points along four different axes, based upon the disclosure provided herein one of ordinary skill in the art will recognize that other embodiments may be implemented by shifting only three copies of the second series of points along three different axes, or shifting five or more copies of the second series of points along five or more different axes. Further, based upon the disclosure provided herein, one of ordinary skill in the art will recognize that in some embodiments, one or more of the first distance, the second distance, the third distance, and/or the fourth distance may be the same as another of the first distance, the second distance, the third distance, and/or the fourth distance. Additionally, one of ordinary skill in the art will recognize that in various embodiments one or more of the first axis, the second axis, the third axis, and/or the fourth axis may be the same as another of the first axis, the second axis, the third axis, and/or the fourth axis. For example, in one particular embodiment, the first axis is the same as the second axis, and the first distance is the same magnitude as the second distance, but in the opposite direction along the same axis (i.e., one distance is the negative of the other distance); and the third axis is the same as the fourth axis, and the third distance is the same magnitude as the fourth distance, but in the opposite direction along the same axis.

Turning to FIGS. 3C-3F a series of four top view, two-dimensional diagrams 302, 303, 304, 305 depict a process of shifting respective copies of the second series of points a distance 331 in a respective direction along four axes 391, 393, 395, 397. As shown in top view, two-dimensional diagram 302 of FIG. 3C, a first copy 333 of second series of points 329 (the first copy of the second series of points is represented using a solid line for clarity) is shifted a distance 331a along axis 391. As shown in top view, two-dimensional diagram 303 of FIG. 3D, a second copy 335 of second series of points 329 (the second copy of the second series of points is represented using a solid line for clarity) is shifted a distance 331b along axis 395. As shown in top view, two-dimensional diagram 304 of FIG. 3D, a second copy 335 of second series of points 329 (the second copy of the second series of points is represented using a solid line for clarity) is shifted a distance 331b along axis 395. As shown in top view, two-dimensional diagram 305 of FIG. 3E, a third copy 337 of second series of points 329 (the third copy of the second series of points is represented using a solid line for clarity) is shifted a distance 331c along axis 393. As shown in top view, two-dimensional diagram 305 of FIG. 3F, a fourth copy 337 of second series of points 329 (the fourth copy of the second series of points is represented using a solid line for clarity) is shifted a distance 331d along axis 397.

In some embodiments, each of distance 331a, distance 331b, distance 331c, and distance 331d are a common distance (i.e., the same magnitude); an angle 399 between axis 391 and axis 397 is ninety (90) degrees, and an angle 398 between axis 393 and axis 395 is ninety (90) degrees. In such an embodiment, axis 391 and axis 395 are a first common axis, and axis 393 and axis 397 are a second common axis. The first common axis and the second common axis are orthogonal. In such an embodiment, first copy 333 of second series of points 329 is shifted in a positive direction by the common distance and second copy 335 of second series of points 329 is shifted in a negative direction by the common distance along the first common axis. Similarly, third copy 337 of second series of points 329 is shifted in a positive direction by the common distance and fourth copy 339 of second series of points 329 is shifted in a negative direction by the common distance along the second common axis. The series of shifts depicted in FIGS. 3C-3F are provided as an example, and one of ordinary skill in the art will recognize a variety of shifts that may be used in relation to different embodiments where distances 331a, 331b, 331c, 331d are varied and/or angles 398, 399 are varied. Further, as mentioned above, more or fewer than the depicted four shifts may be done along a different set of axes in other embodiments.

A third series of points is created by combining all of the points from each of the first copy of the second series of points, the second copy of the second series of points, the third copy of the second series of points, and the fourth copy of the second series of points (block 218). Turning to FIG. 3G, a graphical representation 306 shows all of first copy 333, second copy 335, third copy 337, and fourth copy 339 superimposed on second series of points 329. A complement of a union of first copy 333, second copy 335, third copy 337, and fourth copy 339 is the third series of points. Returning to FIG. 2, the third series of points is reduced to include only the points from the first copy, the second copy, the third copy, and the fourth copy that are both outside the perimeter of and most distant from the second series of points (block 220). This reduction process yields a boundary zone along which injector wells will be located. This boundary zone is outside of the boundary polygon that represents the circumference of a hydrocarbon zone. Turning to FIG. 3H, top view, two-dimensional diagram 307 of a boundary zone 341 is shown extending around the perimeter of second series of points 329. Boundary zone 341 includes: a region 381 along the bottom and left side that includes primarily points from second copy 335, a region 383 along the top side that includes primarily points from fourth copy 339, a region 385 along the right side that includes primarily points from first copy 331, and a region 387 along the bottom and right side that includes primarily points from third copy 337.

Returning to FIG. 2, a number of well points along the boundary zone that are used for each well is calculated (block 222). The number of well points (M) is calculated in accordance with the following equation:

$$M = Well\_Length / N ,$$

where Well_Length is a defined length of each of the wells to be placed along the boundary zone, and N is the distance between each point along the boundary zone. In some embodiments, Well_Length may be user programmable. In other embodiments, the Well_Length is a fixed parameter in a wellbore planning system in which the method is implemented. Based upon the disclosure provided herein, one of ordinary skill in the art will recognize a variety of values for Well_Length that may be used in relation to different embodiments and/or implementations thereof.

A number of spacing points (X) to be included between respective wells located along the boundary zone is calculated (block 224). The number of spacing points (X) is calculated in accordance with the following equation:

$$X = Well\_Spacing / N ,$$

where Well_Spacing is a defined length between adjacent wells along the boundary zone, and N is the distance between each point along the boundary zone. In some embodiments, Well_Spacing may be user programmable. In other embodiments, the Well_Spacing is a fixed parameter in a wellbore planning system in which the method is implemented. Based upon the disclosure provided herein, one of ordinary skill in the art will recognize a variety of values for Well_Spacing that may be used in relation to different embodiments and/or implementations thereof.

One of the points included in the boundary zone is selected as a starting point (TE) of a first well (block 226), and the end point (TD) of the first well is identified as the starting point plus the number of well points (M) (block 228). The following equation is used to identify the endpoint of the first well:

$$TD = TE + M .$$

Once the endpoint of the first well is identified (block 228), a trajectory of the first well is constructed extending from the starting point to the endpoint (block 230). At this juncture, the location of the first well and the trajectory of the first well is complete.

It is determined whether there are enough points in the boundary zone that have not been associated with a well to create at least one more well (block 232). Where the following equation is true, there are enough remaining points in the boundary zone to complete at least one more well:

$$Remaining Points in the Boundary Zone >= M + 2 X .$$

Where enough points in the boundary zone remain to complete at least one more well (block 232), a starting point (TEₙₑₓₜ) for the next well is selected a number of spacing points (X) from the endpoint of the prior well (TD) (block 234). The starting point of the next well is calculated in accordance with the following equation:

$$T {E}_{next} = T {D}_{prior} + X .$$

The processes of blocks 226-234 are repeated until there the number of remaining points in the boundary zone is insufficient to accommodate another well (block 232). Once insufficient points remain in the boundary zone (block 232) all of the locations and trajectories for the injector wells have been completed for the hydrocarbon zone.

Turning to FIG. 3I, an expanded view 308 shows example locations of three (3) injector wells 349, 357, 365 along a portion of boundary zone 341 that extends around the circumference of second series of points 329. The location and trajectory of injector wells 349, 357, 365 are defined using the process of FIG. 2 discussed above. Boundary zone 341 is shown as a number of points each separated by the distance N, and second series of points 329 is shown as a line extending through the respective points for clarity. In this example, the number of well points (M) is selected as five (5), and the number of spacing points is selected as four (4). The trajectory of injector well 349 extends from a TE 345 to a TD 347, and injector well 349 is separated from injector well 357 by a length 351 of four (4) points of boundary zone 341. The trajectory of injector well 357 extends from a TE 353 to a TD 355, and injector well 357 is separated from injector well 365 by a length 359 of four (4) points of boundary zone 341. The trajectory of injector well 365 extends from a TE 361 to a TD 363. In some cases, the wellbore trajectory includes horizontal portion within the boundary zone that runs parallel to the hydrocarbon-water contact.

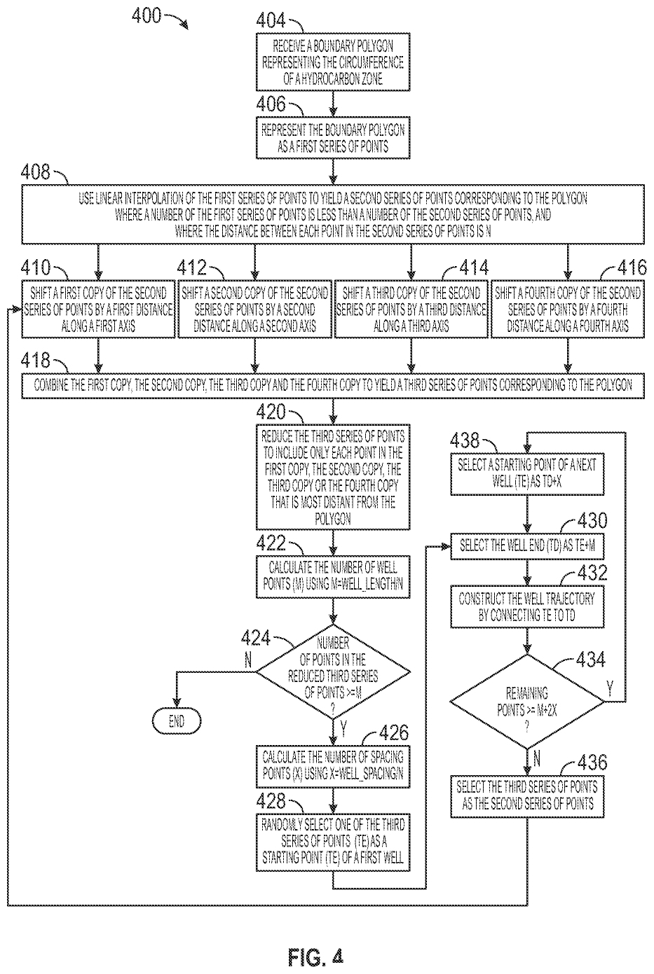

Turning to FIG. 4, a flow diagram 400 shows a method in accordance with one or more embodiments for automatically generating locations for a number of producer wells and well trajectories. In some embodiments, the method is performed by a wellbore planning system. Following follow diagram 400, a boundary polygon representing the circumference of a hydrocarbon zone is received (block 404). This may be the same boundary polygon that was used in locating the injector wells discussed above in relation to FIG. 2.

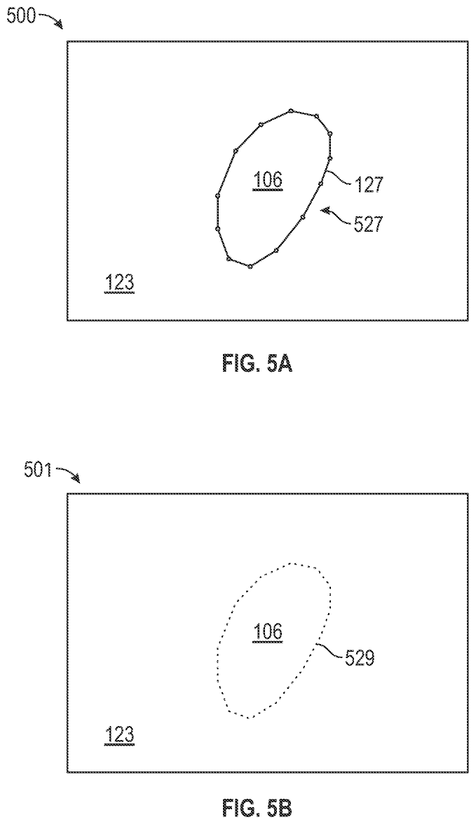

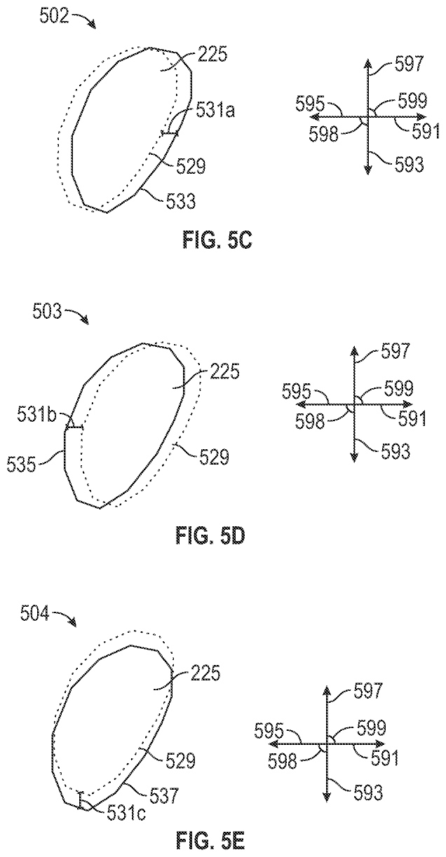

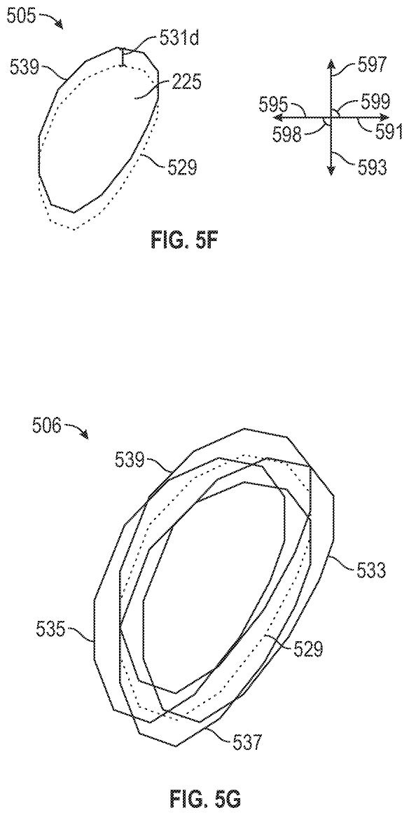

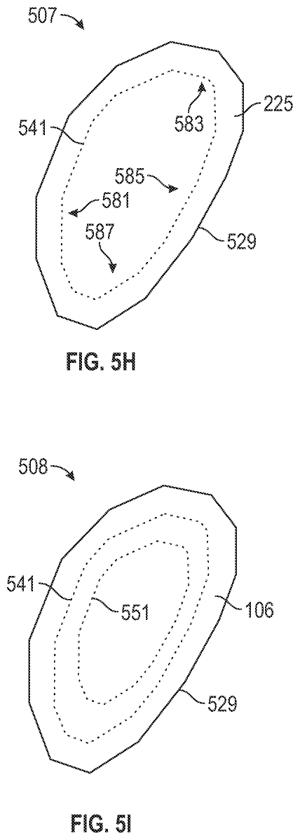

The boundary polygon is represented as a first series of points located at the junction of each of the sides of the boundary polygon (block 406). Turning to FIG. 5A, a top view, two-dimensional diagram 500 shows an example of representing boundary polygon 127 as a first series of points 527 located at the junction of each of the polygon sides.

Returning to FIG. 4, linear interpolation is applied to the first series of points to yield a second series of points extending between respective ones of the first series of points along the perimeter of the boundary polygon (block 408). As discussed above in relation to FIG. 2, the linear interpolation results in a distance N between each of the points of the second series of points. Turning to FIG. 5B, a top view, two-dimensional diagram 501 shows an example of an interpolated second series of points 529 (i.e., the smaller points) extending between respective ones of the first series of points 527 (i.e., the larger points) along the perimeter of the boundary polygon. The distance between each of the second series of points is equal to the distance N.

Returning to FIG. 4, a first copy of the second series of points is shifted by a first distance along a first axis to yield a first shifted-polygon (block 410), a second copy of the second series of points is shifted by a second distance along a second axis to yield a second shifted-polygon (block 412); a third copy of the second series of points is shifted by a third distance along a third axis to yield a third shifted-polygon (block 414); and a fourth copy of the second series of points is shifted by a fourth distance along a fourth axis to yield a fourth shifted-polygon (block 416). The distances of the shifts of each of the copies of the second series of points defines how far away from surrounding region 123 (e.g., an aquifer) that producer wells will be located. While this embodiment is described as shifting four copies of the second series of points along four different axes, based upon the disclosure provided herein one of ordinary skill in the art will recognize that other embodiments may be implemented that involve shifting more or fewer copies of the second series of points along more or fewer axes similar to that discussed above in relation to FIG. 2. In some embodiments, the distances of the shifts of each of the copies of the second series of points are different that the distances used to locate the injector wells as discussed in FIG. 2. Further, in some embodiments, the axes along which the copies of the second series of points are different than those used to locate the injector wells as discussed in FIG. 2. In other embodiments, either or both of the distances of the shifts of each of the copies of the second series of points or the axes along which the shifts are performed are the same as those used to locate the injector wells as discussed in FIG. 2.

Turning to FIGS. 5C-5F a series of four top view, two-dimensional diagrams 502, 503, 504, 505 depict a process of shifting respective copies of the second series of points a distance 531 in a respective direction along four axes 591, 593, 595, 597. As shown in top view, two-dimensional diagram 502 of FIG. 5C, a first copy 533 of second series of points 529 (the first copy of the second series of points is represented using a solid line for clarity) is shifted a distance 531a along axis 591. As shown in top view, two-dimensional diagram 503 of FIG. 5D, a second copy 535 of second series of points 529 (the second copy of the second series of points is represented using a solid line for clarity) is shifted a distance 531b along axis 595. As shown in top view, two-dimensional diagram 504 of FIG. 5D, a second copy 535 of second series of points 529 (the second copy of the second series of points is represented using a solid line for clarity) is shifted a distance 531b along axis 595. As shown in top view, two-dimensional diagram 505 of FIG. 5E, a third copy 537 of second series of points 529 (the third copy of the second series of points being is represented using a solid line for clarity) is shifted a distance 531c along axis 593. As shown in top view, two-dimensional diagram 505 of FIG. 5E, a fourth copy 537 of second series of points 529 (the fourth copy of the second series of points being is represented using a solid line for clarity) is shifted a distance 531d along axis 597.

In some embodiments, each of distance 531a, distance 531b, distance 531c, and distance 531d are a common distance (i.e., the same magnitude); an angle 599 between axis 591 and axis 597 is ninety (90) degrees, and an angle 598 between axis 593 and axis 595 is ninety (90) degrees. In such an embodiment, axis 591 and axis 595 are one common axis, and axis 593 and axis 597 are a second common axis. In such an embodiment, first copy 533 of second series of points 529 is shifted in a positive direction by the common distance and second copy 535 of second series of points 529 is shifted in a negative direction by the common distance along the first common axis. Similarly, third copy 537 of second series of points 529 is shifted in a positive direction by the common distance and fourth copy 539 of second series of points 529 is shifted in a negative direction by the common distance along the second common axis. The series of shifts depicted in FIGS. 5C-5F are provided as an example, and one of ordinary skill in the art will recognize a variety of shifts that may be used in relation to different embodiments where distances 531a, 531b, 531c, 531d are varied and/or angles 598, 599 are varied. Further, as mentioned above, more or fewer than the depicted four shifts may be done along a different set of axes in other embodiments.

A third series of points is created by combining all of the points from each of the first copy of the second series of points, the second copy of the second series of points, the third copy of the second series of points, and the fourth copy of the second series of points (block 418). Turning to FIG. 5G, a graphical representation 506 shows of all of first copy 533, second copy 535, third copy 537, and fourth copy 539 superimposed on second series of points 529. A complement of a union of first copy 533, second copy 535, third copy 537, and fourth copy 539 is the third series of points. Returning to FIG. 2, the third series of points is reduced to include only the points from the first copy, the second copy, the third copy, and the fourth copy that are both inside the perimeter of and most distant from the second series of points (block 420). This reduction process may be done using and intersection function and yields a boundary zone along which producer wells will be located. This boundary zone is within the boundary polygon that represents the circumference of a hydrocarbon zone. Turning to FIG. 5H, top view, two-dimensional diagram 507 of a boundary zone 541 is shown extending within the perimeter of second series of points 529. Boundary zone 541 includes: a region 581 along the bottom and left side that includes primarily points from second copy 535, a region 583 along the top side that includes primarily points from fourth copy 539, a region 585 along the right side that includes primarily points from first copy 531, and a region 587 along the bottom and right side that includes primarily points from third copy 537.

Returning to FIG. 4, a number of well points along the boundary zone that are used for each well is calculated (block 422). The number of well points (M) is calculated similar to that discussed above in relation to FIG. 2. In some cases, the Well_Length is different for producer wells than it is for the injector wells of FIG. 2. It is determined whether the number of points along the boundary zone is sufficient to locate producer well (block 424). The number of points along the boundary zone is sufficient to locate a producer well where the following equation is true:

$$Number of Points Along the Boundary Zone >= M .$$

Where there are enough points in the boundary zone (block 424), a number of spacing points (X) to be included between respective wells located along the boundary zone is calculated (block 426). The number of spacing points (X) is calculated similar to that discussed above in relation to FIG. 2. In some cases the Well_Spacing is different for producer wells than it is for the injector wells of FIG. 2.

One of the points included in the boundary zone is selected as a starting point (TE) of a first well (block 428), and the end point (TD) of the first well is identified as the starting point plus the number of well points (M) (block 430). The following equation is used to identify the endpoint of the first well:

$$TD = TE + M .$$

Once the endpoint of the first well is identified (block 430), a trajectory of the first well is constructed extending from the starting point to the endpoint (block 432). At this juncture, the location of the first well and the trajectory of the first well is complete.

It is determined whether there are enough points in the boundary zone that have not been associated with a well to create at least one more well (block 434). Where the following equation is true, there are enough remaining points in the boundary zone to complete at least one more well:

$$Remaining Points in the Boundary Zone >= M + 2 X .$$

Where enough points in the boundary zone remain to complete at least one more well (block 434), a starting point (TEₙₑₓₜ) for the next well is selected a number of spacing points (X) from the endpoint of the prior well (TD) (block 438). The starting point of the next well is calculated in accordance with the following equation:

$$T {E}_{next} = T {D}_{prior} + X .$$

The processes of blocks 430-438 are repeated until there the number of remaining points in the boundary zone is insufficient to accommodate another well (block 434). Once insufficient points remain in the boundary zone (block 232) all of the locations and trajectories for the injector wells have been completed for the hydrocarbon zone.

Once insufficient points remain in the boundary zone (block 434) all of the locations and trajectories for the producer wells have been completed for this particular boundary zone within the hydrocarbon zone. The current third series of points is used to replace the second series of points (block 436), and the processes of blocks 410-438 are repeated for another boundary zone extending within the previous boundary zone. This process may result in multiple boundary zones defined within the hydrocarbon zone with each hydrocarbon zone being defined within the prior hydrocarbon zone. Turning to FIG. 5I, a graphical representation 508 shows a boundary zone 541 within second series of points 529, and a boundary zone 551 within boundary zone 551. Producer wells are located along each of boundary zones 541, 551 in accordance with the processes of blocks 430-438 and similar to that shown in the placed injector wells of FIG. 3I.

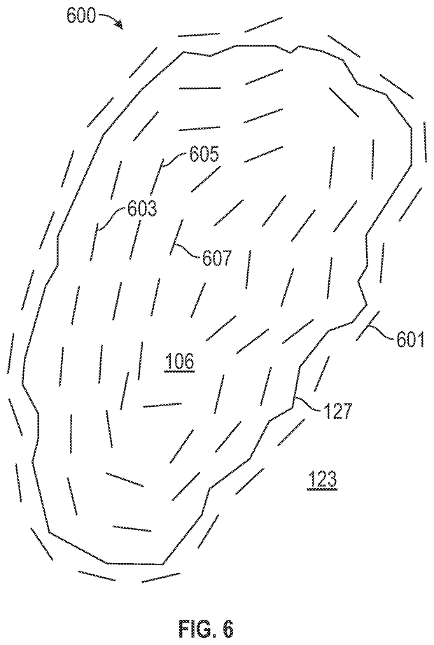

Turning to FIG. 6, an example of a completed well location map 600 is shown that may be generated using the processes of FIGS. 2 and 4 discussed above. As shown, a number of injector wells shown as lines (e.g., injector well 601) extend within surrounding area 123 around the perimeter of boundary polygon 127 that represents the edge of hydrocarbon region 106. These injector wells are located along a single boundary zone. A number of producer wells shown as lines (e.g., producer well 603, producer well 605, and producer well 607) extend within the perimeter of boundary polygon 127 that represents the edge of hydrocarbon region 106. In this example there are three substantially concentric boundary zones with producer well 603 along the outer boundary zone (not shown), producer well 605 along the middle boundary zone (not shown), and producer well 607 along the inner boundary zone (not shown).

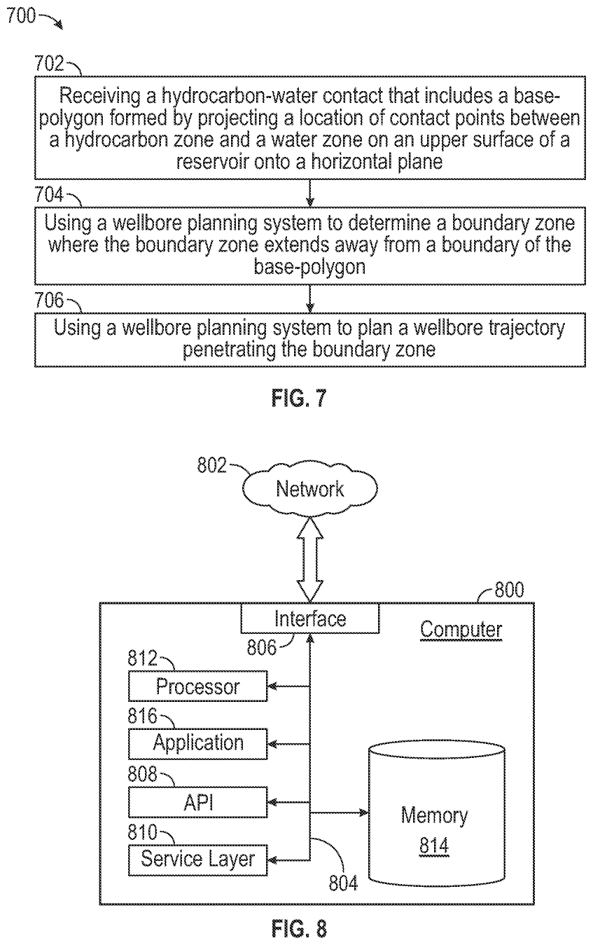

Turning to FIG. 7, a flow diagram 700 shows a method in accordance with some embodiments. Following flow diagram 700, a hydrocarbon-water contact is received (block 702). The hydrocarbon-water contact includes a base-polygon formed by projecting a location of contact points between a hydrocarbon zone and a water zone on an upper surface of a reservoir onto a horizontal plane. Boundary polygon 127 discussed above in relation to FIG. 1B is an example of a base-polygon projected on a horizontal plane. Based upon the disclosure provided herein, one of ordinary skill in the art will recognize other base-polygons that may be used in relation to different embodiments. A boundary zone is determined using a wellbore planning system (block 704). The boundary zone extends away from a boundary of the base-polygon. In some cases, the boundary zone extends away from the boundary of the base-polygon such that it is within the boundary of the base-polygon. In other cases, the boundary zone extends away from the boundary of the base-polygon such that it is outside the boundary of the base-polygon. A wellbore trajectory penetrating the boundary zone is determined using the wellbore planning system (block 706).

Embodiments may be implemented on a computer system. FIG. 8 is a block diagram of a computer system 800 used to provide computational functionalities associated with described algorithms, methods, functions, processes, flows, and procedures as described in the instant disclosure, according to an implementation. Computer system 800 is one example of a large number of computer systems that may be used to implement different embodiments. Based upon the disclosure provided herein, one of ordinary skill in the art will recognize a wide variety of computer systems that may be used in relation to different embodiments.

Computer system 800 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, computer system 800 may include a computer that includes an input device, such as a keypad, keyboard, touch screen, or other device that can accept user information, and an output device that conveys information associated with the operation of computer system 800, including digital data, visual, or audio information (or a combination of information), or a GUI.

Computer system 800 can serve in a role as a client, network component, a server, a database or other persistency, or any other component (or a combination of roles) of a computer system for performing the subject matter described in the instant disclosure. Computer system 800 is communicably coupled with a network 802. In some implementations, one or more components of computer system 800 may be configured to operate within environments, including cloud-computing-based, local, global, or other environment (or a combination of environments).

At a high level, computer system 800 is an electronic computing device operable to receive, transmit, process, store, or manage data and information associated with the described subject matter. According to some implementations, computer system 800 may also include or be communicably coupled with an application server, e-mail server, web server, caching server, streaming data server, business intelligence (BI) server, or other server (or a combination of servers).

Computer system 800 can receive requests over network 802 from a client application (for example, executing on another computer system (not shown) and responding to the received requests by processing the said requests in an appropriate software application. In addition, requests may also be sent to computer system 800 from internal users (for example, from a command console or by other appropriate access method), external or third-parties, other automated applications, as well as any other appropriate entities, individuals, systems, or computers.

Each of the components of computer system 800 can communicate using a system bus 804. In some implementations, any or all of the components of the computer system 800, both hardware or software (or a combination of hardware and software), may interface with each other or interface 806 (or a combination of both) over system bus 804 using an application programming interface (API) 808 or a service layer 810 (or a combination of API 808 and service layer 810. API 808 may include specifications for routines, data structures, and object classes. API 808 may be either computer-language independent or dependent and refer to a complete interface, a single function, or even a set of APIs. Service layer 810 provides software services to computer system 800 or other components (whether or not illustrated) that are communicably coupled to computer system 800. The functionality of computer system 800 may be accessible for all service consumers using this service layer. Software services, such as those provided by service layer 810, provide reusable, defined business functionalities through a defined interface. For example, the interface may be software written in JAVA, C++, or other suitable language providing data in extensible markup language (XML) format or other suitable format. While illustrated as an integrated component of computer system 800, alternative implementations may illustrate API 808 or service layer 810 as stand-alone components in relation to other components of computer system 800 or other components (whether or not illustrated) that are communicably coupled to computer system 800. Moreover, any or all parts of API 808 or service layer 810 may be implemented as child or sub-modules of another software module, enterprise application, or hardware module without departing from the scope of this disclosure.

Computer system 800 includes an interface 806. Although illustrated as a single interface 806 in FIG. 8, two or more interfaces 806 may be used according to particular needs, desires, or particular implementations of computer system 800. Interface 806 is used by computer system 800 for communicating with other systems in a distributed environment that are connected to the network 802. Generally, the interface 806 includes logic encoded in software or hardware (or a combination of software and hardware) and operable to communicate with the network 802. More specifically, the interface 806 may include software supporting one or more communication protocols associated with communications such that the network 802 or interface's hardware is operable to communicate physical signals within and outside of the illustrated computer system 800.

Computer system 800 includes at least one computer processor 812. Although illustrated as a single computer processor 812 in FIG. 8, two or more processors may be used according to particular needs, desires, or particular implementations of computer system 800. Generally, the computer processor 812 executes instructions and manipulates data to perform the operations of computer system 800 and any algorithms, methods, functions, processes, flows, and procedures as described in the instant disclosure.

Computer system 800 also includes a memory 814 that holds data for computer system 800 or other components (or a combination of both) that may be connected to the network 802. For example, memory 814 may be a database storing data consistent with this disclosure. Although illustrated as a single memory 814 in FIG. 8, two or more memories may be used according to particular needs, desires, or particular implementations of computer system 800 and the described functionality. While memory 814 is illustrated as an integral component of computer system 800, in alternative implementations, memory 814 may be external to computer system 800.

In addition to holding data, the memory may be a non-transitory medium storing computer readable instruction capable of execution by computer processor 812 and having the functionality for carrying out manipulation of the data including mathematical computations.

Application 816 is an algorithmic software engine providing functionality according to particular needs, desires, or particular implementations of computer system 800, particularly with respect to functionality described in this disclosure. For example, application 816 can serve as one or more components, modules, applications, etc. Further, although illustrated as a single application 816, application 816 may be implemented as multiple applications 816 on computer system 800. In addition, although illustrated as integral to computer system 800, in alternative implementations, application 816 may be external to computer system 800.

There may be any number of computers 800 associated with, or external to, a computer system containing computer system 800, each computer system 800 communicating over network 802. Further, the term “client,” “user,” and other appropriate terminology may be used interchangeably as appropriate without departing from the scope of this disclosure. Moreover, this disclosure contemplates that many users may use one computer system 800, or that one user may use multiple computers 800.

In some embodiments, computer system 800 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
receiving a hydrocarbon-water contact, wherein the hydrocarbon-water contact comprises a base-polygon formed by projecting a location of contact points between a hydrocarbon zone and a water zone on an upper surface of a reservoir onto a horizontal plane; and
using a wellbore planning system:
determining a boundary zone, wherein the boundary zone extends away from a boundary of the base-polygon, and
planning a wellbore trajectory penetrating the boundary zone.

2. The method of claim 1, further comprising:
drilling, using a wellbore drilling system, a wellbore guided by the planned wellbore trajectory; and
injecting, using a pumping system, a volume of water into the drilled wellbore.

3. The method of claim 2, wherein the boundary zone extends outwards from the boundary of the base-polygon into the water zone, the method further comprising:
planning, using the wellbore planning system, a plurality of wellbore trajectories along the boundary zone, wherein the plurality of wellbore trajectories are distributed at equal circumferential distances;
drilling, using the wellbore drilling system, a plurality of injector wellbores, wherein each of the plurality of injector wellbores is guided by one of the plurality of wellbore trajectories distributed at equal circumferential distances; and
injecting, using the pumping system, a volume of water into each the plurality of drilled injector wellbores.

4. The method of claim 2, wherein the boundary zone extends inwards from the boundary of the base-polygon into the hydrocarbon zone, the method further comprising:
planning, using the wellbore planning system, a plurality of wellbore trajectories along the boundary zone, wherein the plurality of wellbore trajectories are distributed at equal circumferential distances;
drilling, using the wellbore drilling system, a plurality of producer wellbores, wherein each of the plurality of producer wellbores is guided by one of the plurality of wellbore trajectories distributed at equal circumferential distances; and
extracting, using the pumping system, a volume of hydrocarbon from each the plurality of drilled producer wellbores.

5. The method of claim 1, wherein determining the boundary zone, comprises:
forming a set of two orthogonal axes comprising a first axis and a second axis;
forming a first shifted-polygon by shifting the base-polygon by a first distance in a positive direction along the first axis;
forming a second shifted-polygon by shifting the base-polygon by a second distance along a negative direction along the first axis;
forming a third shifted-polygon by shifting the base-polygon by a third distance in a positive direction along the second axis;
forming a fourth shifted-polygon by shifting the base-polygon by a fourth distance along a negative direction along the second axis; and
determining the boundary zone based on a complement of a union of the first, second, third, and fourth shifted-polygons and the base-polygon.

6. The method of claim 5, wherein the first distance, the second distance, the third distance, and fourth distance all have an equal magnitude.

7. The method of claim 1, wherein the wellbore trajectory comprises a horizontal portion within the boundary zone.

8. The method of claim 7, wherein the horizontal portion runs parallel to the hydrocarbon-water contact.

9. The method of claim 1, the method further comprising:
interpolating refinement points between the projection of the location of contact points.

10. The method of claim 1, wherein the hydrocarbon-water contact comprises an isobath.

11. A system, the system comprising:
a wellbore planning system, configured to:
receive a hydrocarbon-water contact, wherein the hydrocarbon-water contact comprises a base-polygon formed by projecting a location of contact points between a hydrocarbon zone and a water zone on an upper surface of a reservoir onto a horizontal plane;
determine a boundary zone, wherein the boundary zone extends outwards from a boundary of the base-polygon into the water zone;
plan a wellbore trajectory penetrating the boundary zone;
a wellbore drilling system, configured to drill a wellbore guided by the planned wellbore trajectory; and
a pumping system, configured to inject a volume of water into the drilled wellbore.

12. A system, comprising a wellbore planning system, configured to:
obtain a hydrocarbon-water contact, wherein the hydrocarbon-water contact comprises a base-polygon formed by projecting a location of contact points between a hydrocarbon zone and a water zone on an upper surface of a reservoir onto a horizontal plane;
determine a boundary zone, wherein the boundary zone extends outwards from a boundary of the base-polygon into the water zone; and
plan a wellbore trajectory penetrating the boundary zone.

13. The system of claim 12, further comprising:
a wellbore drilling system, configured to drill a wellbore guided by the planned wellbore trajectory; and
a pumping system, configured to inject a volume of water into the drilled wellbore.

14. The system of claim 13, wherein:
the wellbore planning system is further configured to plan a plurality of wellbore trajectories penetrating the boundary zone, wherein the plurality of wellbore trajectories are distributed at equal circumferential distances;
the wellbore drilling system is further configured to drill a plurality of wellbores, wherein each of the plurality of wellbores is guided by one of the plurality of wellbore trajectories distributed at equal circumferential distances; and
the pumping system is further configured to inject a volume of water into each the plurality of drilled wellbores.

15. The system of claim 12, wherein the wellbore planning system includes a processor and a computer readable medium coupled to the processor.

16. The system of claim 12, wherein determining the boundary zone, comprises:
forming a set of two orthogonal axes comprising a first axis and a second axis;
forming a first shifted-polygon by shifting the base-polygon by a first distance in a positive direction along the first axis;
forming a second shifted-polygon by shifting the base-polygon by a second distance along a negative direction along the first axis;
forming a third shifted-polygon by shifting the base-polygon by a third distance in a positive direction along the second axis;
forming a fourth shifted-polygon by shifting the base-polygon by a fourth distance along a negative direction along the second axis; and
determining the boundary zone based on a complement of a union of the first, second, third, and fourth shifted-polygons and the base-polygon.

17. The system of claim 16, wherein the first distance, the second distance, the third distance, and fourth distance all have an equal magnitude.

18. The system of claim 12, wherein the wellbore trajectory comprises a horizontal portion within the boundary zone.

19. The system of claim 18, wherein the horizontal portion runs parallel to the hydrocarbon-water contact.

20. The system of claim 12, wherein obtaining the hydrocarbon-water contact further comprises interpolating refinement points between the projection of the location of contact points.
